(19) United States
(12) Patent Application Publication
(10) Pub. No.: US 2002/0083676 A1
(43) Pub. Date: Jul. 4, 2002

(54) Shear friction connection for wood

(76) Inventor: Brian Joseph Rudie, Stillwater, MN (US)

Correspondence Address: BRIAN RUDIE, P.E., WHEELER CONSOLIDATED, 3340 REPUBLIC AVENUE, St. LOUIS PARK, MN, 55426, US

(21) Appl. No.: 09/750,089

(22) Filed: Dec. 29, 2000

(51) Int. Cl. F16D 1/00; E04B 1/18; E04C 5/00

(52) U.S. Cl. 52/698; 52/715; 403/408.1

(57) ABSTRACT

This invention is a mechanical connection for structural wood whereby forces are transferred from one piece to the next by shear friction. Members are placed side-to-side or otherwise in contact along a common friction surface at the point of connection. Shear friction strength is obtained by applying a clamping force, generally perpendicular to the plane of friction, by one or more tightened steel bolts with large washers. The addition of a medium at each friction plane is required to obtain a reliable friction connection. This medium is a thin flat solid material having deformations of sufficient size as to engage the clamping force, even after large volume changes in the wood, such as a thin metal plate with teeth or plugs projecting from both faces or the like.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention pertains to a general purpose and widely versatile high strength mechanical connection for structural wood.

A shear friction mechanism involves the transfer of a force by means of friction along a common surface between two separate bodies at rest. Friction force is a function of the roughness of the material interface and the clamping force perpendicular to the interface. The clamping force may be applied in part prior to the structure being loaded or the force may be due partially or entirely to the actual load to be resisted. The former case can come in the form of tightening of a bolt, and may be considered as an active clamping force. For the latter case, the clamping force is derived or increases as the two members try to separate perpendicular to the friction plane during actual loading. The members try to separate because they must do so to overcome the roughness of the surfaces, thereby making it possible for the members to slip in the direction of applied load. This latter case may be thought of as a passive clamping force.

Because of the large volume changes that can occur in wood, the concept of shear friction is not very practical for direct wood-to-wood connections. An initial clamping force due to pre-tensioning of a bolt can likely be reduced to zero during the service life of a wood structure, particularly in environmentally exposed conditions. For this reason, wood friction connections must rely heavily on passive clamping force. For this same reason, a friction connection without an added medium to enhance the friction probably would not work well in practical applications. Passive clamping force however can easily be fully engaged with the addition of a medium having uniformly distributed deformations, the height of which need only be a small fraction of the member thickness.

Traditional high strength connections for wood can be summarized in the following categories: traditional bolted connections, which transfer forces from one piece to the next through a dowel action mechanism; split ring and shear plate connectors, which transfer force through bearing on the side of the ring; and traditional metal plate connectors, which use a combination of bearing on the face of the teeth and pullout resistance of the teeth, coupled with the tensile strength of the plate itself. The advantages of the present shear friction connection over the aforementioned types are many. With respect to bolted, split ring, and shear plate connections, advantages include less expensive connections, easier assembly with less drilling required and no other cutting or forming, a corresponding smaller section loss, more versatility due to elimination of certain geometrical requirements such as minimum bolt edge distances, and smaller member sizes for those common instances where member sizes would otherwise have had to be increased to accommodate a traditional connection of sufficient strength. With respect to metal plate connections, advantages include more versatility, improved structural integrity, greater applicability to heavy timbers and glu-lams, improved appearance, and greater reliability, particularly for environmentally exposed applications for which connections that rely on pullout resistance are not advisable.

### BRIEF SUMMARY OF THE INVENTION

This invention is a mechanical connection for structural wood whereby forces are transferred from one piece to the next by shear friction. Members are placed side-to-side or otherwise in contact along a common friction surface at the point of connection. Shear friction strength is obtained by applying a clamping force, generally perpendicular to the plane of friction, by one or more tightened steel bolts with large washers. The addition of a medium at each friction plane is required to obtain a reliable friction connection. This medium is a thin flat solid material having deformations of sufficient size as to engage the clamping force, even after large volume changes in the wood, such as a thin metal plate with teeth or plugs projecting from both faces or the like.

### BRIEF DESCRIPTION OF THE SEVERAL VIEWS OF THE DRAWING

FIG. 1 is a perspective view of one possible embodiment of the invention. FIG. 1A is an exploded view of the same. FIG. 2 is a perspective view of a second possible embodiment. FIG. 3 is an elevation view of a third possible embodiment.

FIG. 1A is described as follows: Structural wood members 1, having the same orientation, are positioned side-to-side. Deformed steel plate 2 is placed in the interface between the two members where contact is made. A hole, generally centered on the connection and perpendicular to the friction plane, is drilled through the entire assembly. Steel bolt 3 is inserted through washer 4, wood members 1, deformed plates 2, and another washer 4. Nut 5 is placed on the end of bolt 3 and subsequently tightened to press the deformations of plate 2 into the wood 1, and further tightened to pretension the bolt and elastically compress the wood as much as possible, thereby providing the required clamping force.

FIG. 2 displays a second embodiment in which connected members form a right angle to one another. Two of the total of four deformed plates 2 are shown, these are shown with dashed lines to indicate the fact that they are hidden behind the wood member. Bolt 3 does not penetrate the inner wood members 6 but rather passes between these two members.

FIG. 3 displays a third embodiment in which wood members form an acute angle to one another. This particular connection is best suited to carry a compressive force in the angled wood member 7. The vertical component of the force is then carried by shear friction, the horizontal component by direct compression, which in turn increases the clamping force. Bolt 3 is shown with dashed lines as it is hidden within the wood members. The bolt as shown is not perpendicular to nor centered on the friction plane, but rather is positioned as to optimize the clamping force. Washers 4 are beveled (as shown) or are counter-sunk for this application.

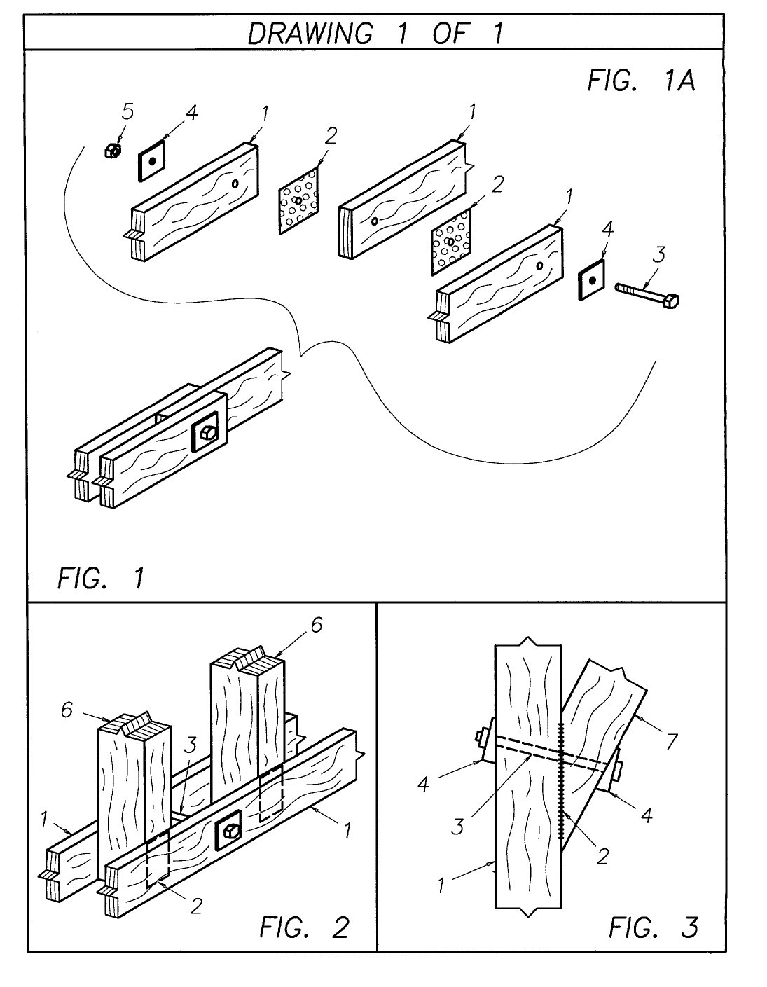

### DETAILED DESCRIPTION OF THE INVENTION

This invention is a mechanical connection for structural wood whereby forces are transferred from one piece to the next by shear friction. This connection is widely versatile and is relevant to innumerable applications in structural engineering. A few applications include truss connections, shear connections for the ends of beams, and splices. Shear friction connections are capable of attaining very high strengths.

The shear friction connection involves two or more members of like or varying orientation, positioned to make contact with each other along one or more common surfaces at the point of connection, referred to as a friction plane. Most commonly, members will be placed side-to-side at the point of connection. When applicable, multiple friction planes within one connection will usually all be parallel. A shear friction mechanism will be used to transmit, from one member to the next, forces that act parallel to the friction plane.

Shear friction strength is obtained by producing a sufficiently rough interface, and by providing a clamping force generally perpendicular to the friction plane.

Clamping force is provided by one or more steel bolts with large washers. Some of the clamping force may be due to the initial tightening or tensioning of the bolt, herein referred to as active clamping force. Some or all of the clamping force may be due to a reaction, by the bolt, to the expansion of the connection as members try to slip relative to one another, herein referred to as passive clamping force. It should be noted that slip is only one possible mode of failure for this connection. Another is a shear fracture of the wood, parallel to and immediately adjacent to the friction plane. An appropriate medium, used in conjunction with a well designed connection, should provide slip resistance well in excess of shear fracture resistance. The bolts are inserted through and generally centered on the connection and generally perpendicular to the friction plane. The bolts are tightened to press the deformations of the medium into the wood, and further tightened to pretension the bolt and elastically compress the wood as much as possible. The bolts are of sufficient size and strength as to provide the required clamping force.

The addition of a medium at each friction plane is required. This medium is a generally thin and flat solid material having sufficient strength and rigidity, and having a large number of uniformly distributed deformations of sufficient size and strength as to engage the clamping force, even after large volume changes in the wood. Desirable characteristics of the medium include a material makeup that would not creep under sustained loading, sufficient rigidity to maintain shape and form when loaded, thin enough as to not unduly offset the wood members, easily drilled, and non-corrosive. Aspects of the projections can vary. Desirable characteristics include a very large number of equally spaced projections, a face that is generally perpendicular to the friction plane and to the direction of applied load, and a magnitude of height and width large enough to provide the required strength without unduly distressing the surface of the wood. One possible solution is a thin steel plate with teeth or plugs projecting from both faces. The surface area of the medium may or may not match the full surface area of the friction plane. Particularly with respect to the failure mode of shear fracture, the surface area of the medium is a major factor in the strength of the connection.

Large, oversized washers are provided at outer surfaces of the wood. Washers are of sufficient size as to prevent crushing of the wood during assembly and as needed to accommodate the required clamping force.

Assembly of the connection begins with wood members being cut and positioned. Deformed metal plates, having been cut to the appropriate size, are placed in the interface between members. The hole or holes, generally centered on the connection and generally perpendicular to the friction plane, are drilled through the entire assembly. Bolts are passed through a washer, the wood assembly, and another washer. A nut is placed on the end of bolt and tightened to press the deformations of the metal plate into the wood, and further tightened to pretension the bolt and elastically compress the wood as much as possible.

The present shear friction connection differs from all existing wood connections in the manner by which forces are transferred from one piece to the next.

What is claimed is:

1. A structural connection for wood, whereby wood members are connected to other wood members along a common surface, hereinafter referred to as friction plane, at discrete locations such as the sides of each member near the end of the member, for the purpose of making truss connections, splices, or other structural connections, and by which forces acting parallel to the friction plane in said members are transferred from one to the other by means of a shear friction mechanism, comprising:
a. a medium, placed between the members where contact is made, at what is referred to as the friction plane, said medium being a generally thin and flat solid material with a large number of uniformly distributed deformations projecting from both faces as necessary to enhance friction sufficiently and therefore maintain load carrying capacity before and after large volume changes in the wood, and which is installed with no prior cutting or forming, such as a thin metal plate with teeth or plugs projecting from both faces or the like,
b. one or more steel bolts, inserted through and generally centered on the connection and generally perpendicular to the friction plane, which are subsequently tightened to press the deformations of said medium into the wood, and further tightened to pretension the bolt and elastically compress the wood as much as possible, and are of sufficient size and strength as to provide the required clamping force,
c. and large washers, at the outer faces of the wood, of sufficient size as to prevent crushing of the wood during assembly and as needed to accommodate the required clamping force.
